(19) United States
(12) Patent Application Publication
(10) Pub. No.: US 2017/0155607 A1
(43) Pub. Date: Jun. 1, 2017

(54) ELECTRONIC MESSAGE CONGLOMERATION

(71) Applicant: International Business Machines Corporation, Armonk, NY (US)

(72) Inventors: Al Chakra, Apex, NC (US); Liam Harpur, Skerries (IE); Erik H. Katzen, Argyle, TX (US); John Rice, Waterford (IE)

(21) Appl. No.: 14/953,467

(22) Filed: Nov. 30, 2015

(51) Int. Cl. H04L 12/58; G06F 17/30; G06F 17/28

(52) U.S. Cl. CPC H04L 51/16; H04L 51/22; G06F 17/28; G06F 17/30601

(57) ABSTRACT

A plurality of electronic messages sent to a first user via at least one communication network can be identified. At least two of the plurality of electronic messages that each include information pertaining to a same topic can be identified by performing natural language processing on the plurality of electronic messages. Responsive to identifying the at least two of the plurality of electronic messages that each include information pertaining to the same topic, a second user who sent at least one of the at least two of the plurality of electronic messages can be prompted to indicate whether the second user chooses to have the at least two of the plurality of electronic messages conglomerated. Responsive to the second user choosing to have the at least two of the plurality of electronic messages conglomerated, the at least two of the plurality of electronic messages can be automatically conglomerated.

### BACKGROUND

The present invention relates to electronic messaging, and more specifically, to managing received electronic messages.

The use of electronic messaging, for example electronic mail (e-mail), text messaging, instant messaging, and social media posts, are commonplace in today's world. Indeed, communications which, in decades past, took place via telephone calls, postal mail delivery and facsimile transmission now oftentimes are implemented using electronic messaging. The use of electronic messaging has added a significant level of convenience to users, while also making the task of communicating more efficient. Conglomeration

### SUMMARY

A method includes identifying a plurality of electronic messages sent to a first user via at least one communication network. The method also can include identifying, using a processor, at least two of the plurality of electronic messages that each include information pertaining to a same topic by performing natural language processing on the plurality of electronic messages. The method also can include, responsive to identifying the at least two of the plurality of electronic messages that each include information pertaining to the same topic, prompting a second user who sent at least one of the at least two of the plurality of electronic messages to indicate whether the second user chooses to have the at least two of the plurality of electronic messages conglomerated. The method also can include, responsive to the second user choosing to have the at least two of the plurality of electronic messages conglomerated, automatically conglomerating the at least two of the plurality of electronic messages.

A system includes a processor programmed to initiate executable operations. The executable operations include identifying a plurality of electronic messages sent to a first user via at least one communication network. The executable operations also can include identifying at least two of the plurality of electronic messages that each include information pertaining to a same topic by performing natural language processing on the plurality of electronic messages. The executable operations also can include, responsive to identifying the at least two of the plurality of electronic messages that each include information pertaining to the same topic, prompting a second user who sent at least one of the at least two of the plurality of electronic messages to indicate whether the second user chooses to have the at least two of the plurality of electronic messages conglomerated. The executable operations also can include, responsive to the second user choosing to have the at least two of the plurality of electronic messages conglomerated, automatically conglomerating the at least two of the plurality of electronic messages.

A computer program includes a computer readable storage medium having program code stored thereon. The program code is executable by a processor to perform a method. The method includes identifying, by the processor, a plurality of electronic messages sent to a first user via at least one communication network. The method also can include identifying, by the processor, at least two of the plurality of electronic messages that each include information pertaining to a same topic by performing natural language processing on the plurality of electronic messages. The method also can include, responsive to identifying the at least two of the plurality of electronic messages that each include information pertaining to the same topic, prompting, by the processor, a second user who sent at least one of the at least two of the plurality of electronic messages to indicate whether the second user chooses to have the at least two of the plurality of electronic messages conglomerated. The method also can include, responsive to the second user choosing to have the at least two of the plurality of electronic messages conglomerated, automatically conglomerating, by the processor, the at least two of the plurality of electronic messages.

### BRIEF DESCRIPTION OF THE DRAWINGS

FIG. 1 is a block diagram illustrating an example of a network data processing system.

FIG. 2 is a pictorial diagram illustrating an example of categorical threads.

FIG. 3 is a pictorial diagram illustrating an example of a digest message.

FIG. 4 is a flow chart illustrating an example of a method of conglomerating a plurality of electronic messages.

FIG. 5 is a block diagram illustrating example architecture for a data processing system.

### DETAILED DESCRIPTION

Arrangements described herein relate to electronic messaging, and more specifically, to managing received electronic messages. In accordance with the present arrangements, a plurality of electronic messages sent to a user can be received, for example by an e-mail client or text messaging client executing on the user's client device or by a server. Natural language processing can be applied to each of the electronic messages to determine whether two or more of the electronic messages include information pertaining to the same topic. Responsive to identifying that two or more of the electronic messages pertain to the same topic, one or more users who generated the electronic messages can be prompted to indicate whether the user(s) choose to have the identified electronic messages conglomerated. Responsive to at least one of such users choosing to have the electronic messages conglomerated, the electronic messages can be conglomerated accordingly. For example, the electronic messages can be conglomerated into a digest message.

Several definitions that apply throughout this document now will be presented.

As defined herein, the term “electronic message” means an electronic mail (e-mail) generated by a person, a text message generated by a person, or a message generated by a person that is posted to a web based forum. A message automatically generated by a system, for example an http request, http response, etc., is not an electronic message as the term “electronic message” is defined herein.

As defined herein, the term “reply message” means an electronic message that is a reply to one or more other electronic messages.

As defined herein, the term “digest message” means an e-mail, a text message or a message that is posted to a web based forum that is automatically generated by a processing system and that includes at least a portion of each of a plurality of electronic messages.

As defined herein, the term “conglomerate” means to gather together into a coherent whole. In illustration, a plurality of messages can be conglomerated into a single message.

As defined herein, the term “natural language analysis” means a process that derives a computer understandable meaning of a human language.

As defined herein, the term “human language” is a language spoken or written by human beings that is not a computer programming language. A “human language” may be referred to as a “natural language.”

As defined herein, the term “web based forum” means is an online discussion site where people can post messages that are viewable by other people. For example, people can hold conversations in a web based forum by posting messages. Some messages posted in a web based forum may be responses to other posted messages, or ask questions related to other posted messages. In one non-limiting arrangement, a web based forum can be hosted by a social networking system.

As defined herein, the term “social networking system” means a system that provides social networking services, for instance via one or more websites. A social networking service is an online service platform on which social networks or social relations are built among people who, for example, share interests, activities, backgrounds or real-life connections, and via which people can share information with one another.

As defined herein, the term “post” means to enter a message in a thread of a web based forum or on a wall of a user in a web based forum. A new thread can be created in which to enter the message, or the message can be entered into an existing thread.

As defined herein, the term “e-mail” means an electronic mail delivered via a communication network to at least one user. An e-mail may be sent by one user to one or more other users. In this regard, an e-mail typically identifies at least recipient using a user name (e.g., e-mail address) corresponding to the recipient, or a group name corresponding to a group of recipients, in at least field within the e-mail, for example within a “To” field, “Cc” field and/or “Bcc” field in a header of the e-mail. A recipient may view an e-mail via an e-mail client, which may execute on a client device or a server to which a client device is communicatively linked.

As defined herein, the term “text message” means a message comprising text delivered via a communication network to at least one user identified as a recipient. A text message may be sent by one user to one or more other users. In this regard, a text message typically identifies at least one recipient using a user name, telephone number or the like. A text message also may comprise audio, image and/or multimedia content. A text message can be delivered, for example, using the short message service (SMS), the text messaging service (TMS) and/or the multimedia messaging service (MMS). A text message also may be referred to as an “instant message.” As defined herein, a text message itself is not a result generated by an Internet search engine per se, although a text message may contain one or more uniform resource identifiers, such as hyperlinks, which can be generated by an Internet search engine and copied, for example by a user (e.g., sender), into the text message. In this regard, if a user uses a web browser to access an Internet search engine to perform an Internet search, and the user receives results from the Internet search engine in the web browser, such results are not a text message as the term text message is defined herein.

As defined herein, the term “client device” means a processing system including at least one processor and memory that requests shared services from a server, and with which a user directly interacts. Examples of a client device include, but are not limited to, a workstation, a desktop computer, a mobile computer, a laptop computer, a netbook computer, a tablet computer, a smart phone, a digital personal assistant, a smart watch, smart glasses, a gaming device, a set-top box and the like. Network infrastructure, such as routers, firewalls, switches, and the like, are not client devices as the term “client device” is defined herein.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “automatically” means without user intervention.

As defined herein, the term “user” means a person (i.e., a human being).

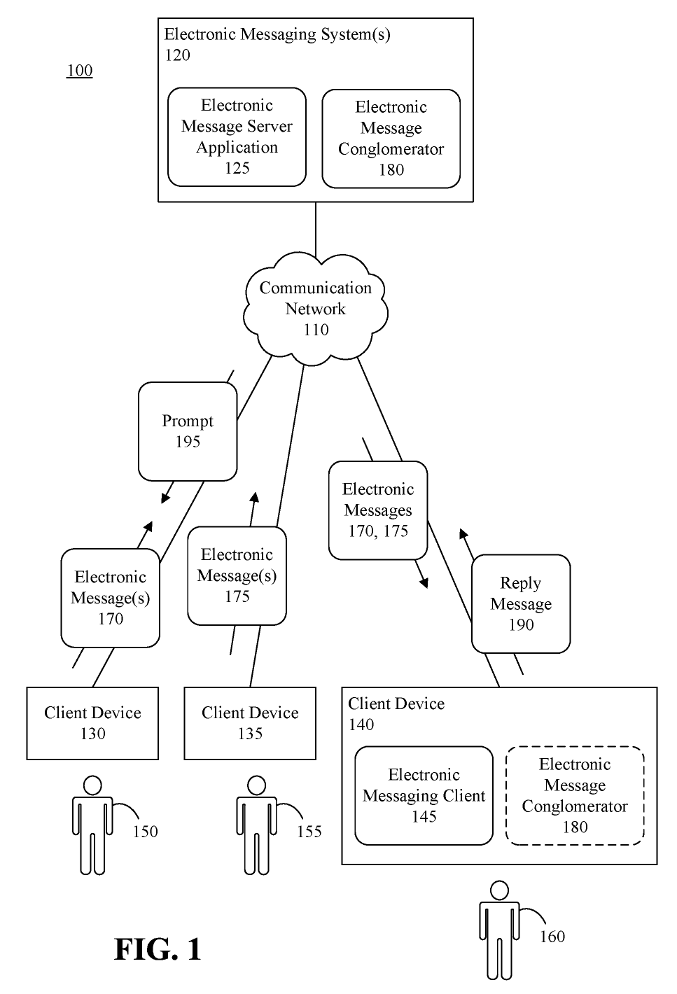

FIG. 1 is a block diagram illustrating an example of a network data processing system 100. The network data processing system 100 contains at least one communication network 110. The communication network 110 is the medium used to provide communications links between various devices and data processing systems connected together within network data processing system 100. The communication network 110 may include connections, such as wire, wireless communication links, or fiber optic cables. The communication network 110 may be implemented as, or include, any of a variety of different communication technologies such as a Wide Area Network (WAN), a Local Area Network (LAN), a wireless network, a mobile or cellular network, a Virtual Private Network (VPN), the Internet, the Public Switched Telephone Network (PSTN), or the like.

The network data processing system 100 also can include one or more electronic messaging systems 120 and a plurality of client devices 130, 135, 140, each of which may couple to the communication network 110. Each electronic messaging systems 120 may be implemented as one or more data processing systems (e.g., servers), each including at least one processor and memory, executing suitable operational software to support the communication of electronic messages. For example, the electronic messaging system 120 can host an electronic message server application 125, such as an e-mail server application, a text messaging server application, or a web forum hosting application.

Optionally, the client device 140 can include an electronic messaging client 145, for example an e-mail client or a text messaging client that receives electronic messages 170, 175 communicated to the user 160 via the electronic message server application 125. In another arrangement, the electronic messaging client 145 can be a mobile application via which the user 160 of the client device 140 accesses electronic messages 170, 175 posted in a web based forum hosted by the electronic message server application 125. In addition to, or in lieu of, the electronic messaging client 145, the client device 140 can include a web browser (not shown) via which the user 160 accesses the electronic messages 170, 175 by interfacing with the electronic message server application 125.

In operation, users 150, 155 of the respective client devices 130, 135 each may send, using respective client devices 130, 135, to the user 160 one or more the respective electronic messages 170, 175. In illustration, the users 150, 155 may send e-mails and/or text messages to the user 160 via the electronic messaging system 120 (e.g., the electronic message server application 125), for example using respective electronic messaging clients or web browsers (not shown). In another arrangement, the users 150, 155 may post messages to the user 160 in a web based forum hosted by the electronic message server application 125, as is well known in the art. Thus, the electronic messages 170, 175 need not all be the same type of electronic message. For example, the electronic messages 170, 175 may include one or more e-mails, texts and/or posts to a web based forum.

In some circumstances, the user 160 may be away from the client device 140 and/or may not interact with the electronic messaging client 145 for significant amount of time, for example, five or more minutes, one or more hours, one or more days, one or more weeks, etc. In illustration, the user may close the electronic messaging client 145 to focus on other work, may take a break or go to lunch, may be out of the office on business or vacation, etc. During that time, the user 160 may receive numerous electronic messages 170, 175 from the users 150, 160, and perhaps even other users. When the user 160 receives a large number of electronic messages 170, 175 while away from the client device 140, that task of reviewing all of the messages can seem daunting and, perhaps, may take a significant amount of time. The arrangements described herein ease this burden by implementing of automated processes that simplify presentation of the electronic messages 170, 175 to the user 160.

In one arrangement, the electronic messaging system 120 can include an electronic message conglomerator 180, for example in an arrangement in which the electronic messages 170, 175 are e-mails, text messages or posts to a web based forum, or the user 160 accesses e-mails or text messages using a web browser. In this arrangement, the electronic message conglomerator 180 can be a module of, or plugin to, the electronic message server application 125, or as a stand-alone application that interfaces with the electronic message server application 125. In another arrangement, the client device 140 can include an electronic message conglomerator 180, for example in an arrangement in which the electronic messages 170, 175 are e-mails or text messages received by the electronic messaging client 145. In such an arrangement, the electronic message conglomerator 180 can be a module of, or plugin to, the electronic messaging client 145, or as a stand-alone application that interfaces with the electronic messaging client 145. In the following examples, unless otherwise noted, it will be assumed that the electronic message conglomerator 180 is executed by an electronic messaging system 120. Nonetheless, it will be understood by those skilled in the art that the electronic messaging system 120 can be executed by a client device, such as the client device 140.

Responsive to detecting that the user 160 has not opened or otherwise accessed electronic messages 170, 175 provided by the electronic message server application 125 within a predetermined period of time, the electronic message conglomerator 180 can determine whether to conglomerate any such electronic messages 170, 175. In another arrangement, the electronic message conglomerator 180 can conglomerate the electronic messages 170, 175 at the behest of the user, or responsive to user defined settings. For example, the user 160 may input a setting indicating that the electronic message conglomerator 180 is to conglomerate electronic messages 170, 175 responsive to the user not being logged into the client device for four or more hours one a work day. In another example, the user can activate the electronic message conglomerator 180 to conglomerate electronic messages 170, 175 when the user is leaving for vacation or taking a business trip.

To conglomerate the electronic messages 170, 175, the electronic message conglomerator 180 can identify two or more of the electronic messages 170, 175 that each include information pertaining to a same topic. Such information may be contained in a subject field or body of the electronic messages 170, 175, or contained in one or more attachments attached to the electronic messages 170, 175.

The electronic message conglomerator 180 can identify the topics of the information contained in each of the electronic messages 170, 175 by implementing natural language processing (NLP) and semantic analysis on the information. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input.

In the case that the information contained in of one or more of the electronic messages 170, 175 includes one or more images and/or multimedia content (e.g., video), the electronic message conglomerator 180 also can identify the topics of the information by processing the images and/or multimedia content. In this regard, the electronic message conglomerator 180 can topics of the images and/or multimedia. For example, the electronic message conglomerator 180 can identify text in images and perform NLP and semantic analysis on such text. The electronic message conglomerator 180 also can identify objects in images and perform image processing known in the art to identify the objects contained in the images, and can identify such objects as being topics. With multimedia content, the electronic message conglomerator 180 can perform speech recognition on audio contained in the multimedia content to convert the audio to text, and perform NLP and semantic analysis on such text. Also, the electronic message conglomerator 180 can identify objects in images contained in the multimedia content and apply image processing known in the art to identify the objects contained in such images.

Responsive to the electronic message conglomerator 180 identifying two or more of the electronic messages 170, 175 that each include information pertaining to a same topic, the electronic message conglomerator 180 can determine a level of correlation of each of such electronic messages 170, 175 to one or more of the other electronic messages 170, 175, and assign to each electronic message 170, 175 a corresponding correlation score. In illustration, if 60% of the information included an electronic message 170 correlates to information contained in an electronic message 175, the electronic message 170 can be assigned a correlation score of 60. When determining the level of correlation among the electronic messages 170, 175, the electronic message conglomerator 180 can disregard pleasantries included in the electronic messages 170, 175 (e.g., Hi John, I hope you had a great vacation) so that the correlation score is not based on a level of correlation among pleasantries. The electronic message conglomerator 180 can identify pleasantries based on the aforementioned NLP and semantic analysis.

Responsive to identifying two or more electronic messages 170, 175 that include information pertaining to the same topic, the electronic message conglomerator 180 can conglomerate such electronic messages 170, 175. In illustration, if the electronic messages each are assigned a correlation score that exceeds a threshold value (e.g., 30) with respect to the correlation of the electronic messages 170, 175 with each other, the electronic message conglomerator 180 can conglomerate those electronic messages 170, 175. By way example, the electronic message conglomerator 180 can generate a message association record, for instance in a data table or the like, indicating the user 160 to whom the electronic messages 170, 175 are sent (and other users of the electronic messages 170, 175 also are sent to other users), each of the two or more electronic messages 170, 175 that include information pertaining to the same topic, the users 150, 155 who sent the two or more electronic messages 170, 175, and at least a portion of the information from each of the electronic messages.

In one aspect, the electronic message conglomerator 180 can conglomerate the electronic messages 170, 175 based, at least in part, on whether the users 150, 155 who sent the electronic messages 170, 175, or a plurality of users who received the electronic messages 170, 175, are members of the same organization, project group or team, social group, or the like. For example, the electronic message conglomerator 180 can conglomerate two or more electronic messages that include information pertaining to the same topic and which are sent by users 150, 155 who are participating on a particular project. The electronic message conglomerator 180 can access a lightweight directory access protocol (LDAP) database or an authentication vault to identify various organizations, project groups or teams, social groups, or the like to which the users 150-160 are assigned.

The message association record also can indicate various options for conglomerating the electronic messages 170, 175. In one arrangement, the electronic message conglomerator 180 can conglomerate the two or more electronic messages 170, 175 by grouping the electronic messages 170, 175 in a categorical thread to which the electronic messages 170, 175 were not previously assigned. For example, the electronic messages 170 received from the user 150 can be contained in a message thread associated with that user 150. Similarly, the electronic messages 175 received from the user 155 can be contained in a message thread associated with that user 155. Nonetheless, the electronic message conglomerator 180 can create a categorical thread and include in that categorical thread the two or more electronic messages 170, 175 that include information pertaining to the same topic, regardless of which other user 150, 155 send the electronic messages 170, 175. The electronic message conglomerator 180 can do the same for other electronic messages (not shown) that include information pertaining the same topic. Further, the electronic message conglomerator 180 can create additional categorical threads for electronic messages 170, 175 that include information pertaining to other topics.

The electronic message conglomerator 180 can interface with the electronic message server application 125 (or the electronic messaging client 145) to cause the electronic message server application 125 (or the electronic messaging client 145) to present to the user 160, via the client device 140, the categorical threads. In illustration, the categorical threads can be presented on a display of the client device 140, for example within the electronic messaging client 145 or a web browser. This can greatly simplify review of the electronic messages 170, 175 by the user 160. For example, the user 160 can access a first categorical thread, and review the electronic messages 170, 175 in that categorical thread that each include the information pertaining to the same topic. Then the user can access a second categorical thread and review electronic messages 170, 175 pertaining to another topic. Accordingly, the user can focus on one topic at a time while reviewing the electronic messages 170, 175.

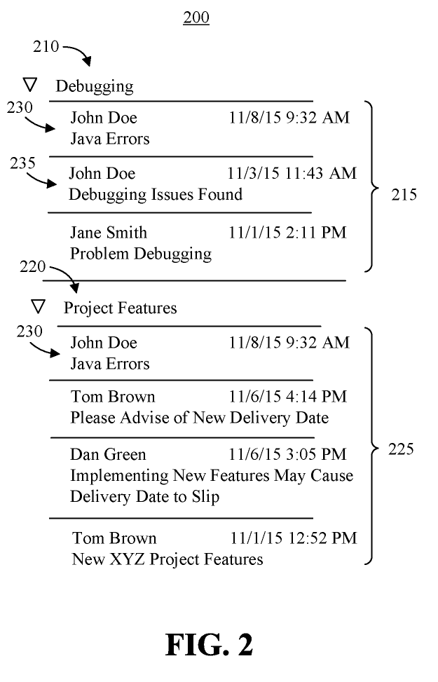

FIG. 2 is a pictorial diagram illustrating an example of categorical threads 200. The categorical threads 200 can include a first categorical thread 210 pertaining to a first topic and a second categorical thread 220 pertaining to a second topic. The categorical threads 200 also can include one or more other categorical threads (not shown). The categorical thread 210 can include each of the electronic messages 215 added to that categorical thread 210 by the electronic message conglomerator 180, for example each of the electronic messages that includes information pertaining to debugging. Similarly, the categorical thread 220 can include each of the electronic messages 225 added to that categorical thread 220 by the electronic message conglomerator 180, for example each the electronic messages that includes information pertaining to project features. As noted, the electronic messages 215 need not all be the same type of electronic message, and the electronic messages 225 need not all be the same type of electronic message. For example, the electronic messages 215 may include e-mails, texts and/or posts to one or more web based forums, and the electronic messages 225 also may include e-mails, texts and/or posts to one or more web based forums. In some cases, a particular electronic message may include information pertaining to more than one topic. Optionally, in such cases the electronic message conglomerator 180 can include that message in more than one categorical thread 210, 220.

Further, the electronic message conglomerator 180 can indicate in each electronic message 215, 225 the portion of the electronic message that pertains to the topic of the categorical thread 210, 220 in which the electronic message is included. For example, the electronic message conglomerator 180 can present a summary of each of the electronic messages 215, 225. In illustration, the user 160 can define a template to be used for presenting the electronic messages 215, 225, and the electronic messages 215, 225 can be presented in the categorical thread 210, 220 according to the template. Within the template, the user can define various fields to be presented in each of the electronic messages 215, 225 presented in the categorical threads 210, 220. For example, the user 160 can define a field for a user identifier of a sender, a send date/time, the summary, etc.

If a particular electronic message 230 is included in each of the categorical threads 210, 220, responsive to the user opening or accessing the electronic message from the categorical thread 210, the electronic message conglomerator 180 can highlight, underline, or visually indicate in any other suitable manner the information in that electronic message 230 that pertains the topic of the categorical thread 210. Similarly, responsive to the user opening or accessing the electronic message 230 from the categorical thread 220, the electronic message conglomerator 180 can highlight, underline, or visually indicate in any other suitable manner the information in that electronic message 230 that pertains the topic of the categorical thread 220. Accordingly, the user 160 can easily find and review information contained in the electronic messages 215, 225 pertaining the topic for which the user is reviewing the electronic messages 215, 225.

In a further arrangement, the electronic message conglomerator 180 can summarize each of the electronic messages 215, 225, and the summary of a particular electronic message 215, 225 can be presented to the user responsive to the user opening or accessing the electronic message 215, 225. In illustration, the electronic message conglomerator 180 can display in the summary for the electronic message 235 only the name of the user who sent the electronic message 235 and the information contained in the electronic message 235 that pertains to the topic for the categorical thread 210. In this regard, the electronic message conglomerator 180 can exclude from the display of the summary or more pleasantries that may be included in the electronic message 235 and/or other information not related to the topic. In one arrangement, the user who has opened or accessed the summary can choose to be presented the entire electronic message 235, for example by selecting a corresponding menu item or double clicking on the summary.

Referring again to FIG. 1, in another arrangement, the electronic message conglomerator 180 can conglomerate the two or more electronic messages 170, 175 that include information pertaining to the same topic by creating a digest message, and include in the digest message at least a portion of each of the electronic messages 170, 175 containing information pertaining to that topic. The user can open or access the digest message to review such information. Thus, the user can review information from a plurality of the electronic messages 170, 175 that pertains to the same topic, saving the user much time in reviewing the electronic messages 170, 175. The electronic messages 170, 175 for which information is included in the digest message need not all be the same type of electronic message. For example, the digest message can include information from one or more e-mails, text messages and/or posts to one or more web based forums.

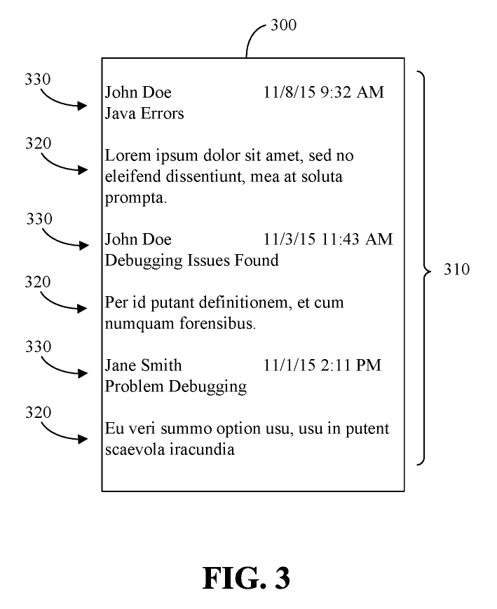

FIG. 3 is a pictorial diagram illustrating an example of a digest message 300. The electronic message conglomerator 180 can include in the digest message 300 at least a portion of each of a plurality of electronic messages 310, each of the plurality of electronic messages 310 containing information 320 pertaining to a particular topic. The electronic message conglomerator 180 also can include in the digest message 300 information 330 indicating who sent each electronic message 310, the subject of each electronic message 310 and when each electronic message 310 was sent. The electronic message conglomerator 180 can exclude from the digest message 300 pleasantries contained in the electronic messages 310 and information contained in the electronic messages 310 that are not pertinent to the topic. In one arrangement, the user can select from the digest message 300 any of the electronic messages 310 to open or access the entire electronic message, for example by selecting a corresponding menu item or double clicking on the electronic message 310.

In one arrangement, the electronic message conglomerator 180 can configure the digest message 300 based on one or more user defined settings. For example, the user can specify that electronic messages 310 are to be presented in an order based on when the electronic messages 310 sent, grouped based on who sent the electronic messages 310 or grouped together based on the information contained in the electronic messages 310. For example, if two or more of the electronic messages 310 contain the same question or similar questions, the electronic message conglomerator 180 can group such electronic messages 310 together in the digest message 300. In a further example, the electronic messages 310 contain the same question or similar questions can be meshed together, for example to appear as though each of the questions are asked in a single electronic message 310.

Referring again to FIG. 1, the user 160 may choose to send a reply message 190 responding to a plurality of electronic messages 170, 175 that are conglomerated. For example, the user 160 can select a particular categorical thread (210, 220 in FIG. 2) or digest message (300 in FIG. 3) and select a menu item to create the reply message 190. In response, the electronic message conglomerator 180 can prompt the user 160 to indicate whether the user 160 chooses the reply message 190 to be sent as the reply to each of the plurality of electronic messages 170, 175 that are conglomerated. Responsive to the user 160 indicating that the user 160 chooses the reply message 190 to be sent as a reply to each of the plurality of electronic messages 170, 175 that are conglomerated, communicating the reply message to each of a plurality of respective users who generated the at least two of the plurality of electronic messages that are conglomerated, the electronic message conglomerator 180 can present to the user 160 the reply message 190, for example, in the electronic messaging client 145 or a web browser executing on the client device 140.

The reply message 190 can include at least a recipient field indicating users to whom the reply message 190 is to be sent and a content field in which the user can enter content for the reply message 190. The reply message 190 can be, for example, based on a reply message template, which may be pre-configured by the user 160 to include various fields and content selected or input by the user chooses. For example, the user 160 can define the template to include a standard pleasantry to be automatically included in the reply message 190, and the electronic message conglomerator 180 can auto populate the pleasantry to the reply message 190. In another example, the electronic message conglomerator 180 can recognize reply message patterns based on previous reply messages sent by the user, and automatically include various fields in the reply message 190 based on those patterns. The electronic message conglomerator 180 also can auto populate a recipient field of the electronic message window to include as recipients each of the users 150, 155 who sent electronic messages included in the categorical thread or the digest message. The user 160 can add users to or remove users from the field as the user 160 so chooses, the user 160 can enter content into the content field, and the user 160 can edit or delete information that may have been auto populated to the reply message 190 by the electronic message conglomerator 180. Responsive to the user 160 selecting to send the reply message 190, the electronic message conglomerator 180 can communicate the reply message 190 to each of the indicated recipients.

In one aspect of the present arrangements, the electronic message conglomerator 180 can send a plurality of versions of the reply message 190. For example, the electronic message conglomerator 180 can send the reply message 190 as two or more of an e-mail, a text message and a post to a web based forum. In illustration, assume that the reply message 190 is a reply to three different electronic messages 170, 175, one of which is an e-mail from the user 150, one of which is a text message from the user 155 and one of which is a post to a web based forum by another user. Thus, the electronic message conglomerator 180 can send the reply message 190 to the user 150 as an e-mail, send the reply message 190 to the user 155 as a text message, and send the reply message 190 to the other user as a post in the web based forum. Accordingly, the user can respond to multiple related electronic messages 170, 175 with a single reply message 190, regardless of the manner in which the electronic messages 170, 175 are communicated to the user 160.

Referring again to FIG. 1, in one arrangement, the electronic message conglomerator 180 can prompt users 150, 155 who send electronic messages 170, 175 to the user 160 to indicate whether such users 150, 155 choose to have the electronic messages 170, 175 conglomerated with other electronic messages 170, 175. Responsive to the users 150, 155 indicating that they choose to have the electronic messages 170, 175 conglomerated, the electronic message conglomerator 180 can conglomerate the electronic messages 170, 170 as previously described.

In illustration, the electronic message conglomerator 180 can identify a first electronic message 170 sent by the user 150 to the user 160. In response, the electronic message conglomerator 180 can perform NLP, semantic analysis and/or image processing on the first electronic message 170 and, based on such processing, create a first analytics record for the first electronic message 170. The first analytics record can indicate one or more topics contained in the information included in the first electronic message 170, indicating the user 150 and indicating the user 160. The electronic message conglomerator 180 can process the information contained in the first analytics record to other analytics records to determine whether the first electronic message 170 includes information pertaining to the same topic as one or more other electronic messages 170, 175 that are sent to the same user 160. For this example, it will be assumed that the first electronic message 170 does not include any such information.

At some other time, the electronic message conglomerator 180 can identify a second electronic message 170 sent by the user 150 to the user 160. In response, the electronic message conglomerator 180 can perform NLP, semantic analysis and/or image processing on the second electronic message 170 and, based on such processing, generate a second analytics record for the second electronic message 170. The electronic message conglomerator 180 can process the information contained in the second analytics record to other analytics records to determine whether the second electronic message 170 includes information pertaining to the same topic as one or more other electronic messages 170, 175 that are sent to the same user 160. In another arrangement, the user 150 can provide an indication that the second electronic message 170 pertains to the same topic as one or more other electronic messages 170, 175 that are sent to the same user 160. For example, the user 150 can select one or more menu items indicating that the second electronic message 170 message pertains to the same topic as one or more other electronic messages 170, 175 that are sent to the same user 160. The electronic message conglomerator 180 can detect such user selection. In the case that the user selection is performed using an electronic messaging client 145, the electronic messaging client can include with the second electronic message 170 metadata indicating the user selection. The electronic message conglomerator 180 can detect the metadata.

For this example, it will be assumed that the second electronic message 170 includes information pertaining to the same topic as information included in the first electronic message 170. Responsive to determining that the second electronic message 170 includes information pertaining to the same topic as information included in the first electronic message 170, and identifying that both the first and second electronic messages 170 are sent by the user 150 to the user 160, the electronic message conglomerator 180 can communicate a prompt 195 to the client device 130 prompting the user 150 to indicate whether the user chooses to conglomerate the first and second electronic messages 170. Responsive to the user choosing to have the first and second electronic messages 170 conglomerated, the electronic message conglomerator 180 can include both the first and second electronic messages 170 in the same categorical thread and/or digest message. In another arrangement, the electronic message conglomerator 180 can combine the information contained in the first and second electronic messages 170 into a single conglomerated message. Further, the electronic message conglomerator 180 can present to the user 150 the conglomerated message for further review and/or editing. Responsive to the user 150 sending the conglomerated message, the electronic message conglomerator 180 can replace the first electronic message 170 with the conglomerated message. Accordingly, rather than receiving both the first electronic message 170 and the second electronic message 170, the user 160 can open or access the single conglomerated message, which can save the user 160 time in reviewing the information.

In another example, assume that the user 155 sent an electronic message 175 to the user 160 and a corresponding first analytics record has been generated for the electronic message 175, as previously described. At some other time, the electronic message conglomerator 180 can identify an electronic message 170 sent by the user 150 to the user 160. In response, the electronic message conglomerator 180 can generate a corresponding second analytics record. The electronic message conglomerator 180 can process the information contained in the second analytics record to other analytics records to determine whether the electronic message 170 includes information pertaining to the same topic as one or more other electronic messages 170, 175 that are sent to the same user 160. In another arrangement, the user 155 can provide an indication that the second electronic message 175 pertains to the same topic as one or more other electronic messages 170, 175 that are sent to the same user 160. For example, the user 155 can select one or more menu items indicating that the second electronic message 175 message pertains to the same topic as one or more other electronic messages 170, 175 that are sent to the same user 160. The electronic message conglomerator 180 can detect such user selection. In the case that the user selection is performed using an electronic messaging client 145, the electronic messaging client can include with the second electronic message 175 metadata indicating the user selection. The electronic message conglomerator 180 can detect the metadata.

For this example, it will be assumed that the electronic message 170 includes information pertaining to the same topic as information included in the electronic message 175. Responsive to determining that the electronic message 170 includes information pertaining to the same topic as information included in the electronic message 175, and identifying that both the electronic messages 170 and the electronic message 175 are sent to the user 160, the electronic message conglomerator 180 can communicate a prompt 195 to the client device 130 prompting the user 150 to indicate whether the user chooses to conglomerate the electronic message 170 with the electronic message 175. Responsive to the user 150 choosing to conglomerate the electronic message 170 with the electronic message 175, the electronic message conglomerator 180 can conglomerate the electronic message 170 and the electronic message. For example, the electronic message conglomerator 180 can include both the electronic messages 170 and the electronic message 175 in the same categorical thread and/or digest message. In another arrangement, the electronic message conglomerator 180 can combine the information contained in the electronic message 170 and the electronic message 175 into a single conglomerated message. In the conglomerated message, the electronic message conglomerator 180 can indicate which user 150, 155 sent the various information. In this example, because the electronic messages 170, 175 are sent by different users 150, 155, the electronic message conglomerator 180 need not provide an option for the user 150 to review or edit the conglomerated message.

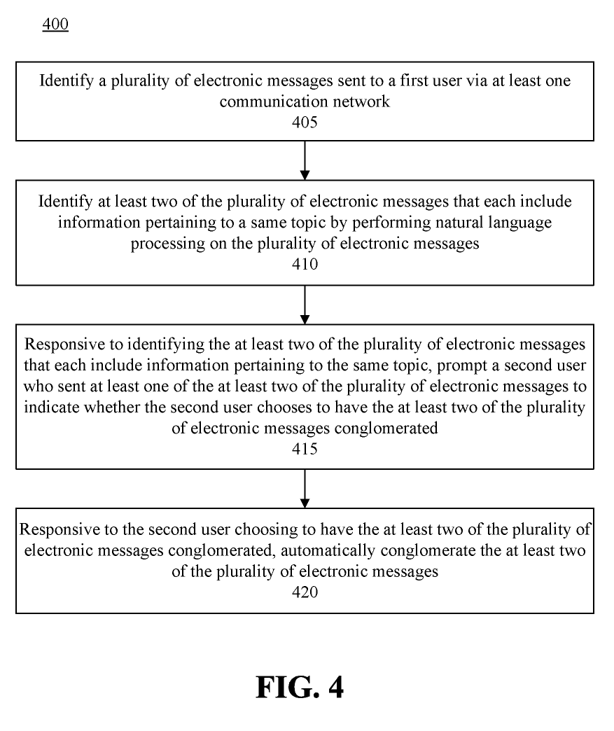

FIG. 4 is a flow chart illustrating an example of a method 400 of conglomerating a plurality of electronic messages. At step 405, an electronic message conglomerator executed by a processor can identify a plurality of electronic messages sent to a first user via at least one communication network. At step 410, the electronic message conglomerator can identify at least two of the plurality of electronic messages that each include information pertaining to a same topic by performing natural language processing on the plurality of electronic messages. At step 415, responsive to identifying the at least two of the plurality of electronic messages that each include information pertaining to the same topic, the electronic message conglomerator can prompt a second user who sent at least one of the at least two of the plurality of electronic messages to indicate whether the second user chooses to have the at least two of the plurality of electronic messages conglomerated. At step 420, responsive to the second user choosing to have the at least two of the plurality of electronic messages conglomerated, the electronic message conglomerator can automatically conglomerate the at least two of the plurality of electronic messages

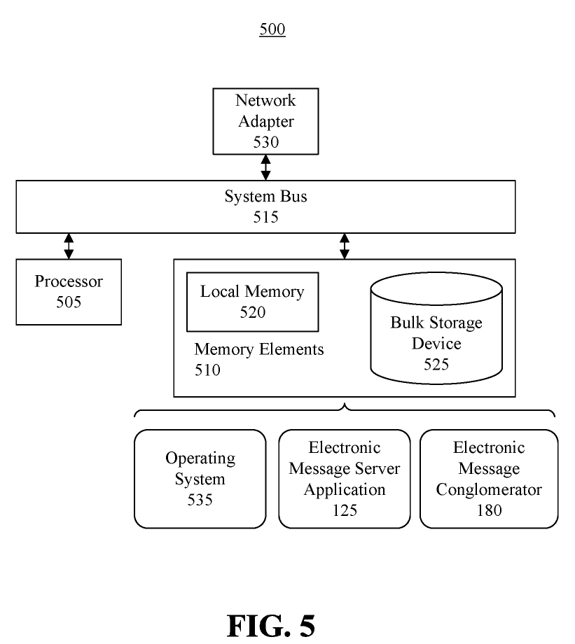

FIG. 5 is a block diagram illustrating example architecture for the electronic messaging system 120 of FIG. 1.

The electronic messaging system 120 can include at least one processor 505 (e.g., a central processing unit) coupled to memory elements 510 through a system bus 515 or other suitable circuitry. As such, the electronic messaging system 120 can store program code within the memory elements 510. The processor 505 can execute the program code accessed from the memory elements 510 via the system bus 515. It should be appreciated that the electronic messaging system 120 can be implemented in the form of any system including a processor and memory that is capable of performing the functions and/or operations described within this specification. For example, the electronic messaging system 120 can be implemented as one or more hardware servers.

The memory elements 510 can include one or more physical memory devices such as, for example, local memory 520 and one or more bulk storage devices 525. Local memory 520 refers to random access memory (RAM) or other non-persistent memory device(s) generally used during actual execution of the program code. The bulk storage device(s) 525 can be implemented as a hard disk drive (HDD), solid state drive (SSD), or other persistent data storage device. The electronic messaging system 120 also can include one or more cache memories (not shown) that provide temporary storage of at least some program code in order to reduce the number of times program code must be retrieved from the bulk storage device 525 during execution.

One or more network adapters 530 can be coupled to electronic messaging system 120 to enable the electronic messaging system 120 to become coupled to other systems, computer systems, remote printers, and/or remote storage devices through intervening private or public networks. Modems, cable modems, transceivers, and Ethernet cards are examples of different types of network adapters 530 that can be used with the electronic messaging system 120.

As pictured in FIG. 5, the memory elements 510 can store an operating system 535, as well as the electronic messaging server application 125 and the electronic message conglomerator 180 of FIG. 1. Being implemented in the form of executable program code, the operating system 535, electronic messaging server application 125 and electronic message conglomerator 180 can be executed by the processor 505. For example, the processor can execute the electronic messaging server application 125 and electronic message conglomerator 180 within a computing environment provided by the operating system 535 in order to perform the processes described herein that are performed by these elements. As such, the operating system 535, electronic messaging server application 125 and electronic message conglomerator 180 can be considered part of the electronic messaging system 120. Moreover, the operating system 535, electronic messaging server application 125 and electronic message conglomerator 180 are functional data structures that impart functionality when employed as part of the electronic messaging system 120.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
identifying a plurality of electronic messages sent to a first user via at least one communication network;
identifying, using a processor, at least two of the plurality of electronic messages that each include information pertaining to a same topic by performing natural language processing on the plurality of electronic messages;
responsive to identifying the at least two of the plurality of electronic messages that each include information pertaining to the same topic, prompting a second user who sent at least one of the at least two of the plurality of electronic messages to indicate whether the second user chooses to have the at least two of the plurality of electronic messages conglomerated; and
responsive to the second user choosing to have the at least two of the plurality of electronic messages conglomerated, automatically conglomerating the at least two of the plurality of electronic messages.

2. The method of claim 1, wherein automatically conglomerating the at least two of the plurality of electronic messages comprises:
creating a digest message comprising the information pertaining to the same topic identified in the at least two of the plurality of electronic messages.

3. The method of claim 2, further comprising:
receiving from the second user or a third user another electronic message;
receiving from the second user or the third user an indication that the other electronic message pertains to the same topic identified in the at least two of the plurality of electronic messages; and
responsive to receiving from the second user or the third user the indication that the other electronic message pertains to the same topic identified in the at least two of the plurality of electronic messages, automatically adding to the digest message information contained in the other electronic message that pertains to the same topic identified in the at least two of the plurality of electronic messages.

4. The method of claim 2, further comprising:
receiving from the second user or a third user another electronic message;
determining whether the other electronic message includes information pertaining to the same topic identified in the at least two of the plurality of electronic messages by performing natural language processing on the other electronic message; and
responsive to determining that the other electronic message includes information pertaining to the same topic identified in the at least two of the plurality of electronic messages, automatically adding to the digest message information contained in the other electronic message that pertains to the same topic identified in the at least two of the plurality of electronic messages.

5. The method of claim 1, wherein automatically conglomerating the at least two of the plurality of electronic messages comprises:
creating a categorical thread comprising the at least two of the plurality of electronic messages that each include information pertaining to the same topic.

6. The method of claim 1, further comprising:
responsive to the first user initiating generation of a reply message responding to at least one of the at least two of the plurality of electronic messages that are conglomerated, prompting the first user to indicate whether the first user chooses the reply message to be sent as a reply to each of the at least two of the plurality of electronic messages that are conglomerated; and
responsive to the first user indicating that the first user chooses the reply message to be sent as the reply to each of the at least two of the plurality of electronic messages that are conglomerated, communicating the reply message to each of a plurality of respective users who generated the at least two of the plurality of electronic messages that are conglomerated.

7. The method of claim 1, wherein the at least two of the plurality of electronic messages that each include information pertaining to the same topic comprise a first electronic message that is an electronic mail or a text message, and a second electronic message that is a post to a web based forum.

8. A system, comprising:
a processor programmed to initiate executable operations comprising:
identifying a plurality of electronic messages sent to a first user via at least one communication network;
identifying at least two of the plurality of electronic messages that each include information pertaining to a same topic by performing natural language processing on the plurality of electronic messages;
responsive to identifying the at least two of the plurality of electronic messages that each include information pertaining to the same topic, prompting a second user who sent at least one of the at least two of the plurality of electronic messages to indicate whether the second user chooses to have the at least two of the plurality of electronic messages conglomerated; and
responsive to the second user choosing to have the at least two of the plurality of electronic messages conglomerated, automatically conglomerating the at least two of the plurality of electronic messages.

9. The system of claim 8, wherein automatically conglomerating the at least two of the plurality of electronic messages comprises:
creating a digest message comprising the information pertaining to the same topic identified in the at least two of the plurality of electronic messages.

10. The system of claim 9, the executable operations further comprising:
receiving from the second user or a third user another electronic message;
receiving from the second user or the third user an indication that the other electronic message pertains to the same topic identified in the at least two of the plurality of electronic messages; and
responsive to receiving from the second user or the third user the indication that the other electronic message pertains to the same topic identified in the at least two of the plurality of electronic messages, automatically adding to the digest message information contained in the other electronic message that pertains to the same topic identified in the at least two of the plurality of electronic messages.

11. The system of claim 9, the executable operations further comprising:
receiving from the second user or a third user another electronic message;
determining whether the other electronic message includes information pertaining to the same topic identified in the at least two of the plurality of electronic messages by performing natural language processing on the other electronic message; and
responsive to determining that the other electronic message includes information pertaining to the same topic identified in the at least two of the plurality of electronic messages, automatically adding to the digest message information contained in the other electronic message that pertains to the same topic identified in the at least two of the plurality of electronic messages.

12. The system of claim 8, wherein automatically conglomerating the at least two of the plurality of electronic messages comprises:
creating a categorical thread comprising the at least two of the plurality of electronic messages that each include information pertaining to the same topic.

13. The system of claim 8, the executable operations further comprising:
responsive to the first user initiating generation of a reply message responding to at least one of the at least two of the plurality of electronic messages that are conglomerated, prompting the first user to indicate whether the first user chooses the reply message to be sent as a reply to each of the at least two of the plurality of electronic messages that are conglomerated; and
responsive to the first user indicating that the first user chooses the reply message to be sent as the reply to each of the at least two of the plurality of electronic messages that are conglomerated, communicating the reply message to each of a plurality of respective users who generated the at least two of the plurality of electronic messages that are conglomerated.

14. The system of claim 8, wherein the at least two of the plurality of electronic messages that each include information pertaining to the same topic comprise a first electronic message that is an electronic mail or a text message, and a second electronic message that is a post to a web based forum.

15. A computer program product comprising a computer readable storage medium having program code stored thereon, the program code executable by a processor to perform a method comprising:
identifying, by the processor, a plurality of electronic messages sent to a first user via at least one communication network;
identifying, by the processor, at least two of the plurality of electronic messages that each include information pertaining to a same topic by performing natural language processing on the plurality of electronic messages;
responsive to identifying the at least two of the plurality of electronic messages that each include information pertaining to the same topic, prompting, by the processor, a second user who sent at least one of the at least two of the plurality of electronic messages to indicate whether the second user chooses to have the at least two of the plurality of electronic messages conglomerated; and
responsive to the second user choosing to have the at least two of the plurality of electronic messages conglomerated, automatically conglomerating, by the processor, the at least two of the plurality of electronic messages.

16. The computer program product of claim 15, wherein automatically conglomerating the at least two of the plurality of electronic messages comprises:
creating a digest message comprising the information pertaining to the same topic identified in the at least two of the plurality of electronic messages.

17. The computer program product of claim 16, the method further comprising:
receiving from the second user or a third user another electronic message;
receiving from the second user or the third user an indication that the other electronic message pertains to the same topic identified in the at least two of the plurality of electronic messages; and
responsive to receiving from the second user or the third user the indication that the other electronic message pertains to the same topic identified in the at least two of the plurality of electronic messages, automatically adding to the digest message information contained in the other electronic message that pertains to the same topic identified in the at least two of the plurality of electronic messages.

18. The computer program product of claim 16, the method further comprising:
receiving from the second user or a third user another electronic message;
determining whether the other electronic message includes information pertaining to the same topic identified in the at least two of the plurality of electronic messages by performing natural language processing on the other electronic message; and
responsive to determining that the other electronic message includes information pertaining to the same topic identified in the at least two of the plurality of electronic messages, automatically adding to the digest message information contained in the other electronic message that pertains to the same topic identified in the at least two of the plurality of electronic messages.

19. The computer program product of claim 15, wherein automatically conglomerating the at least two of the plurality of electronic messages comprises:
creating a categorical thread comprising the at least two of the plurality of electronic messages that each include information pertaining to the same topic.

20. The computer program product of claim 15, the method further comprising:
responsive to the first user initiating generation of a reply message responding to at least one of the at least two of the plurality of electronic messages that are conglomerated, prompting the first user to indicate whether the first user chooses the reply message to be sent as a reply to each of the at least two of the plurality of electronic messages that are conglomerated; and
responsive to the first user indicating that the first user chooses the reply message to be sent as the reply to each of the at least two of the plurality of electronic messages that are conglomerated, communicating the reply message to each of a plurality of respective users who generated the at least two of the plurality of electronic messages that are conglomerated.
